(19) United States
(12) Patent Application Publication
(10) Pub. No.: US 2003/0103014 A1
(43) Pub. Date: Jun. 5, 2003

(54) Antenna and shield

(76) Inventors: Thomas Birnbaum, Santa Cruz, CA (US); Thomas G. Wolf, Mountain View, CA (US)

Correspondence Address: QUALCOMM Incorporated, Attn: Patent Deparment, 5775 Morehouse Drive, San Diego, CA, 92121-1714, US

(21) Appl. No.: 10/006,040

(22) Filed: Dec. 4, 2001

(51) Int. Cl. H01Q 1/52

(52) U.S. Cl. 343/841; 343/702

(57) ABSTRACT

A method of manufacture, which in one implementation includes but is not limited to forming at least one electromagnetic shield and at least one antenna in substantial electrical current communication (e.g., 102). A system, which in one implementation includes but is not limited to at least one electromagnetic shield and at least one antenna formed in substantial electrical current communication (e.g., 304, 308).

### BACKGROUND OF THE INVENTION

1. Field of the Invention

The present application relates, in general, to electromagnetic shields and antennas.

2. Description of the Related Art

Electromagnetic shields may be described as devices which block electrical and/or magnetic energy. Electromagnetic shields are often used with electrical circuitry to block electromagnetic energy from impinging upon and/or disrupting the normal operation of the electrical circuitry. Electromagnetic shields are also often used to prevent electromagnetic energy radiated by the operation of electrical circuitry from impinging upon and/or interfering with the normal operation of other electrical systems in the proximity of the electrical circuitry. The design, use, and manufacture of electromagnetic shields in the foregoing-described fashion is often treated as a technical field or subdiscipline known as “electromagnetic compatibility” (EMC), since the shields are used to ensure that electrical devices operating in proximity to each other do not adversely interfere with and/or disturb each other (i.e., are electromagnetically compatible with each other). Electromagnetic shields are typically deliberately connected to ground potential (either local circuit ground, or earth ground depending upon the application).

Electromagnetic antennas are devices which are structured to either transmit or receive electromagnetic energy waveforms. Many antenna designs include points on the antenna that are at ground potential. In addition, some antennas have linear structures, planar structures, or even more complex structures that are at ground potential and form an integral part of the antenna. The design, use, and manufacture of devices for the purpose of either receiving or transmitting electromagnetic energy waveforms are often treated as a technical field or subdiscipline known as “antenna design.”

Historically, in the related art, technical issues related to EMC and antenna design have been treated separately due to the essentially opposite orientations of EMC and antenna design (e.g., EMC is focused on blocking/absorbing radiated electromagnetic energy, while antenna design is focused on transmitting/receiving radiated electromagnetic energy). Accordingly, in the related art electromagnetic shields and electromagnetic antennas are separately designed and manufactured.

In contradistinction to the teachings and methodology of the related art, the inventors of the subject matter described herein (the inventors) have discovered that advantageous structures and methods can be achieved by considering EMC and antenna design issues together, rather than separately.

### SUMMARY OF THE INVENTION

In one implementation, a method of manufacture includes but is not limited to forming at least one electromagnetic shield and at least one antenna in substantial electrical current communication.

In another implementation, a system includes but is not limited to at least one electromagnetic shield and at least one antenna formed in substantial electrical current communication.

In yet another implementation, a wireless device includes but is not limited to at least one electromagnetic shield and at least one antenna formed in substantial electrical current communication.

The foregoing is a summary and thus contains, by necessity, simplifications, generalizations, and omissions of detail; consequently, those skilled in the art will appreciate that the summary is illustrative only and is NOT intended to be in any way limiting. Other aspects, inventive features, and advantages of the devices and/or processes described herein, as defined solely by the claims, will become apparent in the non-limiting detailed description set forth herein.

### BRIEF DESCRIPTION OF THE DRAWINGS

FIG. 1 shows a high-level logic flowchart illustrating a process of manufacture FIG. 2 depicts an alternate implementation of the process shown in FIG. 1.FIGS. 3A-3C illustrate an example of forming a structure in accordance with various aspects of the alternate process implementations shown in FIGS. 1 and 2, as well as an example of how the formed structure can be employed in a device or system.FIGS. 4A-4C show an example of forming a structure in accordance with various aspects of the alternate process implementations shown in FIGS. 1 and 2, as well as an example of how the formed structure can be employed in a device or system.FIGS. 5A-5B depict an example of forming a structure in accordance with various aspects of the alternate process implementations shown in FIGS. 1 and 2, as well as an example of how the formed structure can be employed in a device or system.FIGS. 6A-6B depict an example of forming a structure in accordance with various aspects of the alternate process implementations shown in FIGS. 1 and 2, as well as an example of how the formed structure can be employed in a device or system.FIG. 8 shows a PIFA antenna modified to provide enhanced operation in some applications. FIG. 7 shows that the Inverted F antenna 308 of FIG. 3B can be alternatively oriented below spacer 306 (e.g., which could be achieved by bending the sheet metal such that Inverted F antenna 308, as it is shown in FIG. 3B, is rotated 180 degrees about an axis formed by the intersection of the Inverted F antenna 308 and the spacer 306).

The use of the same or similar reference symbols in different drawings generally refers to same or similar parts.

### DETAILED DESCRIPTION OF THE PREFERRED EMBODIMENTS

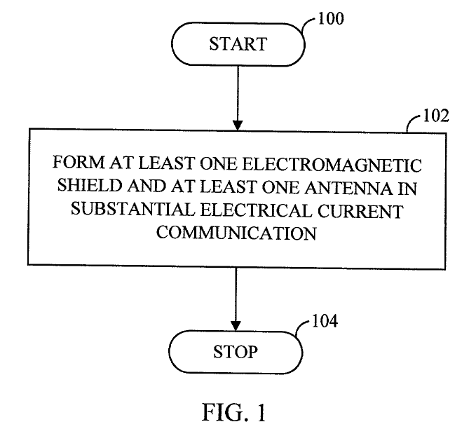

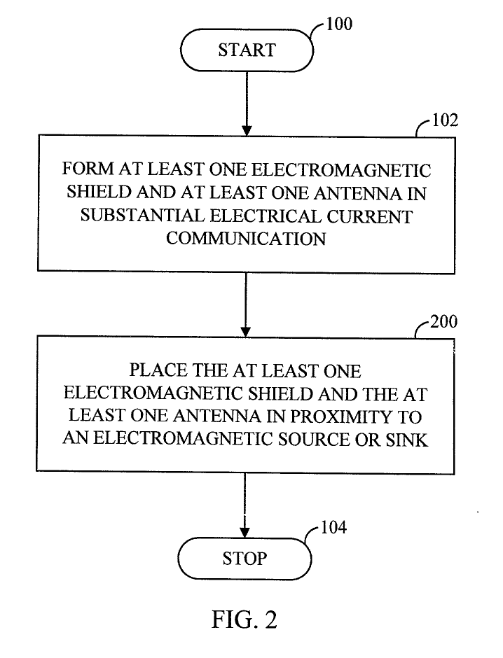

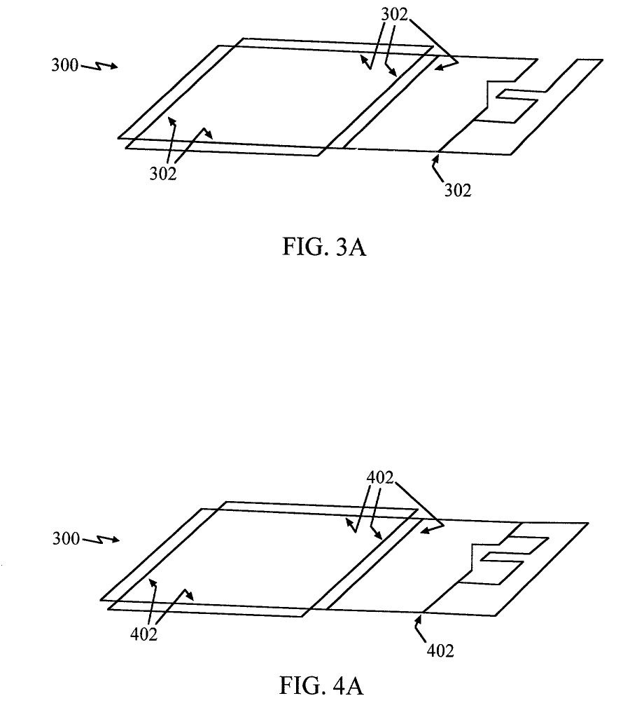

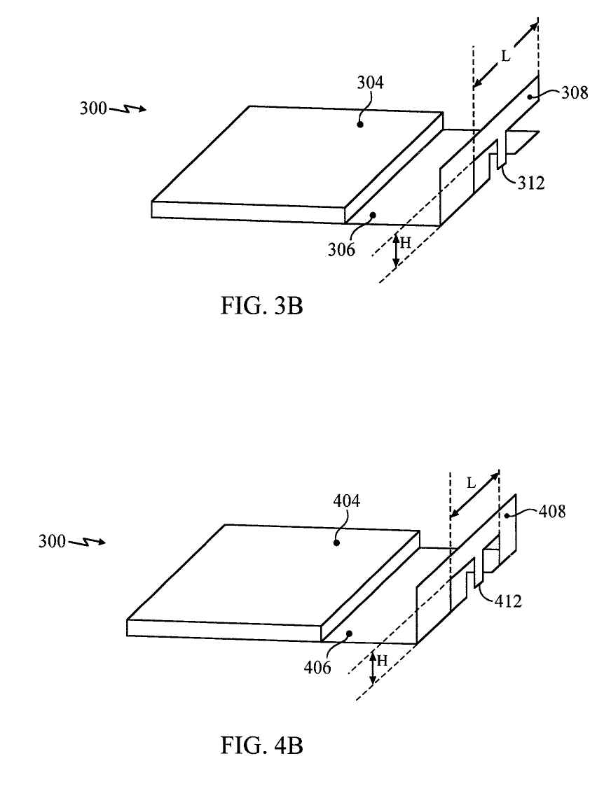

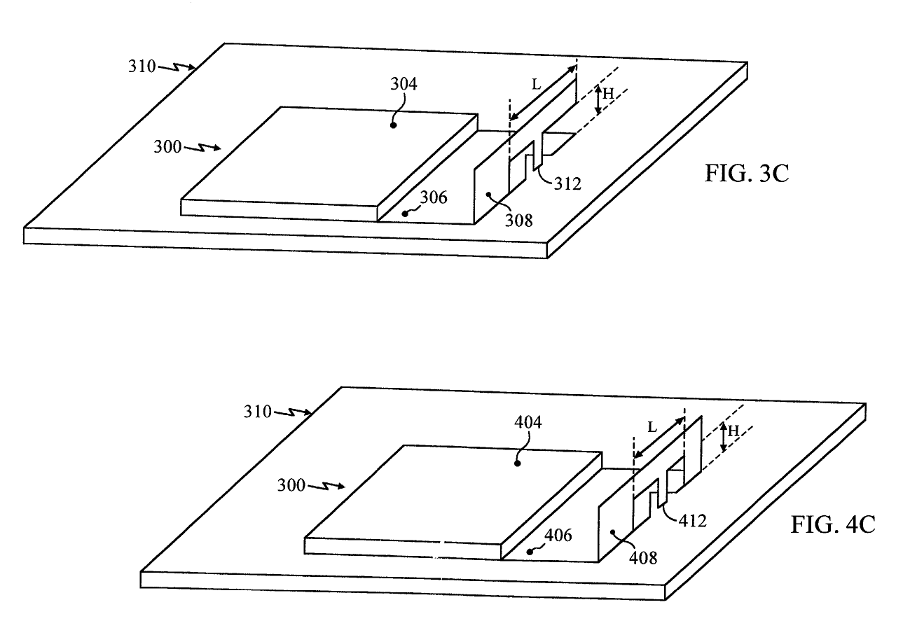

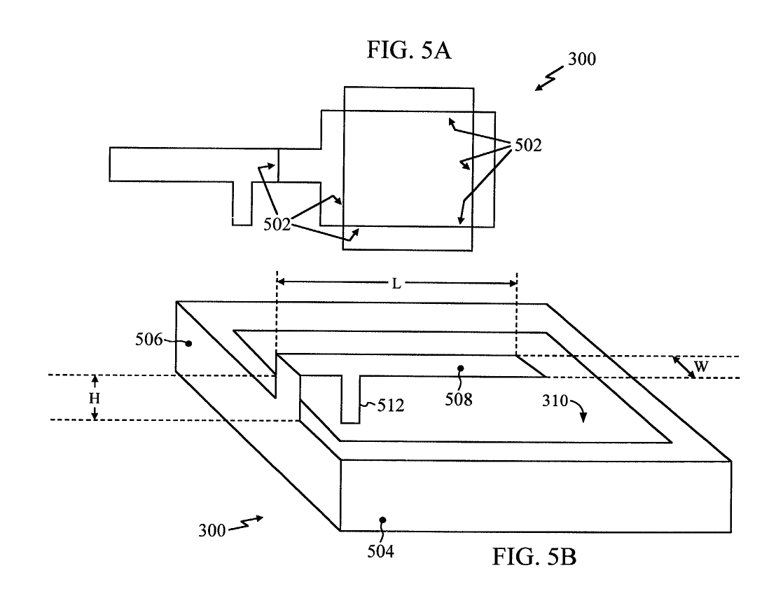

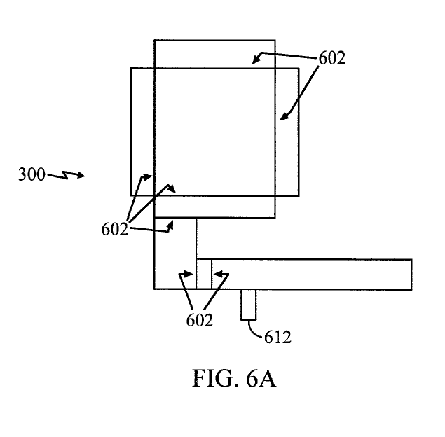

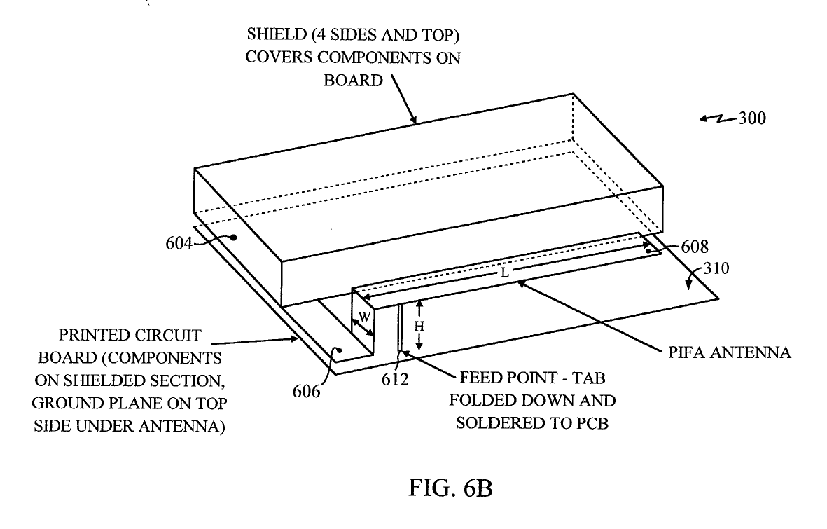

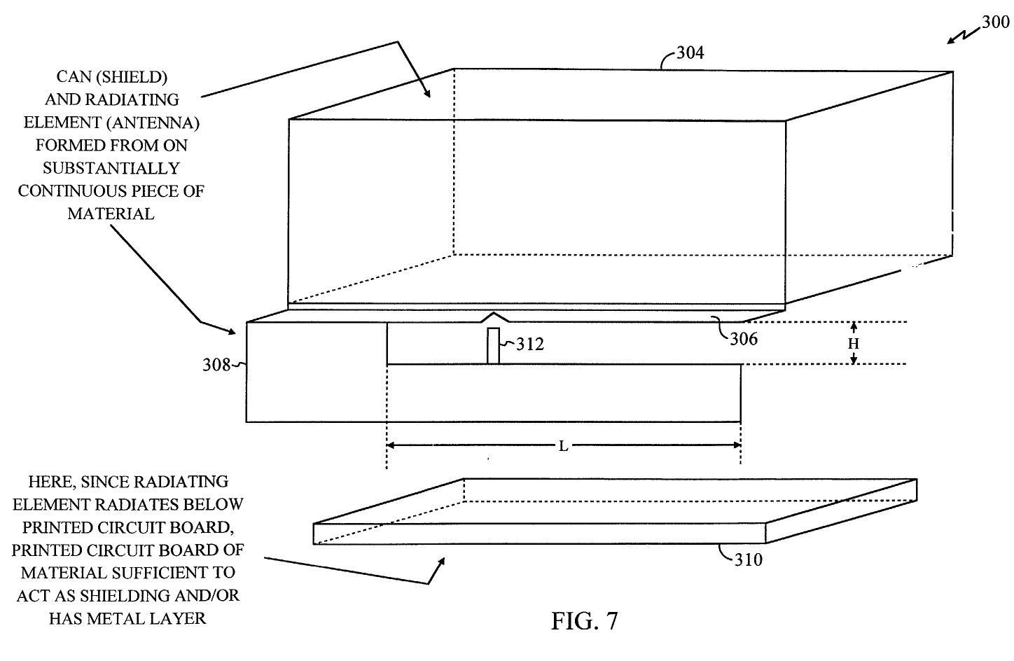

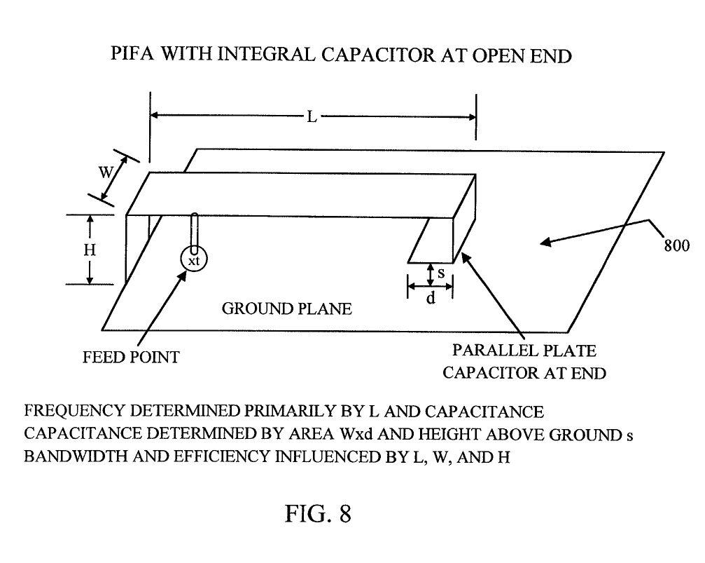

As noted above, in contradistinction to the teachings and methodology of the related art, the inventors have discovered that advantageous structures and methods can be achieved by considering EMC and antenna design issues together, rather than separately. Accordingly, following are described advantageous methods and systems which treat electromagnetic shields and electromagnetic antennas together, rather than separately as is done in the related art. With reference to the figures, and in particular with reference now to FIG. 1, shown is a high-level logic flowchart illustrating a process of manufacture. Method step 100 depicts the start of the process. Method step 102 illustrates the step of forming at least one electromagnetic shield and at least one antenna in substantial electrical current communication (e.g., such that electrical charges can actually be transferred between the at least one electromagnetic shield and at least one antenna, as opposed to mere electrical field transmission between the at least one electromagnetic shield and at least one antenna). In one implementation, method step 102 is achieved via forming the electromagnetic shield and the antenna from a substantially continuous piece of conductive material. In another implementation, method step 102 is achieved via forming the electromagnetic shield and antenna separately and thereafter electrically connecting (e.g., mechanically as opposed to coupling only by electromagnetic fields) the shield and antenna via an electrically conductive material. In yet another implementation, method step 102 is achieved via forming the electromagnetic shield and antenna from different conductive materials, and thereafter electrically connecting the shield and antenna via an electrically conductive material. In yet another implementation, method step 102 is achieved via electrically interconnecting the electromagnetic shield and antenna via a conductive spacer which provides a separation between the electromagnetic shield and antenna (e.g., although the separations will vary with different applications, in general the spacer will provide separation of at least 1/50^{th} of the intended wavelength of the antenna). Method step 104 shows the end of the process. With respect to method step 102, those having ordinary skill in the art may wonder why, if the at least one shield is in electrical current communication with the at least one antenna, the at least one shield doesn't electrically short the at least one antenna. The inventors have recognized that since many antenna designs include points or structures on the antenna that are at ground potential and an EMC shield is at ground potential and is highly conductive, using the shield or a portion of it to form the ground contacts, or any other grounded structures in the antenna, is equivalent to creating a separate ground structure for the antenna. However, be that as it may, the inventors have also discovered that there needs to be enough space between the shield and the antenna such that the presence of the shield does not unduly interfere with the operation of the antenna. The inventors have found empirically that, for an antenna intended for a particular frequency, if the shield is spaced farther than ⅛^{th} (one eighth) of an intended wavelength from the antenna (where the intended wavelength is equal to the speed of light in air divided by the frequency for which the antenna is intended), the structure will work well in most applications, but that if the shield is spaced nearer than 1/50^{th} (one fiftieth) of the intended wavelength from the antenna, the structure will only perform well in a certain limited subset of applications.

Those having ordinary skill in the art will recognize that the “antenna” referred to in method step 102 can include, but is not limited to, a Planar Inverted F Antenna (PIFA), a slot antenna, a dipole antenna, a monopole antenna or other type of antenna which those employing the described process may find advantageous to utilize (e.g., virtually any antenna typically fashioned from wire). Those having ordinary skill in the art will recognize that the “conductive materials” referenced in relation to method step 102 can include but are not limited to metals or other types of conductors typically employed in the art (e.g., graphite compounds, or metallic coatings over plastic). Those having ordinary skill in the art will recognize that the “electromagnetic shield” referred to in method step 102 can include but is not limited to a full enclosure (or can), a partial enclosure (e.g., open in one or more directions), a perforated enclosure, a screen enclosure, or others types of shields typically employed in the art provided the shield is empirically determined to function as an effective ground structure at the frequencies of interest (e.g. perforations and openings must be small compared to a wavelength of the signals being shielded).

Those having ordinary skill in the art will recognize that the “forming at least one electromagnetic shield and at least one antenna in substantial electrical current communication” referred to in method step 102 can include, but is not limited to, punching at least a part of a substantially continuous piece of conductive material from a sheet of the material (e.g., via sheet metal manufacturing techniques); stamping a sheet of the substantially continuous piece of conductive material (e.g., via sheet metal manufacturing techniques); bending the substantially continuous piece of conductive material (e.g., via manufacturing techniques); or molding the at least one electromagnetic shield and the at least one antenna (e.g., injection molding the at least one electromagnetic shield and the at least one antenna).Referring now to FIG. 2, depicted is an alternate implementation of the process shown in FIG. 1. Illustrated in FIG. 2 is additional method step 200 which shows placing the at least one electromagnetic shield and the at least one antenna in proximity to an electromagnetic source or sink. The remaining steps of FIG. 2 function as elsewhere described herein.Those having ordinary skill in the art will recognize that the “placing the at least one electromagnetic shield and the at least one antenna in proximity to an electromagnetic source or sink” referred to in method step 200 can include, but is not limited to, placing the at least one electromagnetic shield and the at least one antenna in proximity to electrical circuitry selected from an electrical-circuitry group including, but not limited to, electrical circuitry having at least one discrete electrical circuit, electrical circuitry having at least one integrated circuit, electrical circuitry having at least one application specific integrated circuit, electrical circuitry forming a general purpose computing device configured by a computer program, electrical circuitry forming a memory device, electrical circuitry forming a transmitter, electrical circuitry forming a receiver, and electrical circuitry forming a communications device. Examples of placing the at least one electromagnetic shield and the at least one antenna in proximity to electrical circuitry are using the at least one electromagnetic shield and the at least one antenna in a wireless communications system, a Global Positioning System, a wireless modem system, a wireless factory automation system, etc. Other examples of placing the at least one electromagnetic shield and the at least one antenna in proximity to electrical circuitry are using the at least one electromagnetic shield and the at least one antenna in a wireless device selected from the wireless-device group including but not limited to at least one cellular-enabled wireless device, at least one TDMA-enabled wireless device, at least one CDMA-enabled wireless device, at least one GPS-enabled wireless device, and at least one email-enabled wireless device.With reference now to FIGS. 3A-3C, illustrated is an example of forming a structure in accordance with various aspects of the alternate process implementations shown in FIGS. 1 and 2, as well as an example of how the formed structure can be employed in a device or system. FIG. 3A depicts a substantially continuous piece of conductive material 300 (e.g., a piece of sheet metal), which has been formed such that when the substantially continuous piece of conductive material 300 is bent along the dashed lines 302, at least one electromagnetic shield and at least one antenna will be formed. FIG. 3B illustrates the substantially continuous piece of conductive material 300 (e.g., a piece of sheet metal) where the metal has been bent (or stamped) along dashed lines 302 shown in FIG. 3A in order to form an electromagnetic shield 304, a spacer 306, and an Inverted F antenna 308 having antenna feed 312. In general, the spacer 306 has dimensions and is oriented to provide a separation between the electromagnetic shield 304 and the Inverted F antenna 308, where the separation is generally, but not always, at least 1/50^{th} of the wavelength associated with an operational frequency of interest of the Inverted F antenna 308. FIG. 3C shows the electromagnetic shield 304, the spacer 306, and the Inverted F antenna 308 of FIG. 3A placed in proximity to electrical circuitry on a printed circuit board 310 (which is typically part of a system or wireless device), where the printed circuit board 310 typically has a ground plane (not shown); in one embodiment, antenna feed 312 is soldered to and excited by an antenna feed connection (not shown) on the printed circuit board 310.

In passing, the inventors note that in the majority of implementations discussed herein, there is no explicit return path specified for electrical energy injected into described antennas. The reason for this is that the inventors are using what is sometimes referred to in the art as a “relative ground” approach to drive the antenna. In this approach, electrical energy is fed/taken from a single antenna feed point, and the non-antenna portions of the structure are allowed to supply/absorb charge in the same way a return path to “true” electrical ground would if the circuit were connected to true electrical ground. Another way to describe the use of the relative ground approach is that in one implementation the inventors are using at least a part of the non-antenna portion of the formed structure as a ground for the electrical circuit which injects energy which causes the at least one antenna to radiate.Referring now to FIGS. 4A-4C, shown is an example of forming a structure in accordance with various aspects of the alternate process implementations shown in FIGS. 1 and 2, as well as an example of how the formed structure can be employed in a device or system. FIG. 4A depicts a substantially continuous piece of conductive material 300 (e.g., a piece of sheet metal), which has been formed such that when the substantially continuous piece of conductive material 300 is bent along the dashed lines 402, at least one electromagnetic shield and at least one antenna will be formed. FIG. 4B illustrates the substantially continuous piece of conductive material 300 (e.g., a piece of sheet metal) where the metal has been bent (or stamped) along dashed lines 402 shown in FIG. 4A in order to form the electromagnetic shield 404, the spacer 406, and the slot antenna 408 having antenna feed 412. In general, the spacer 406 has dimensions and is oriented to provide a separation between the electromagnetic shield 404 and the slot antenna 408, where the separation is generally, but not always, at least 1/50^{th} of the wavelength associated with an operational frequency of interest of the slot antenna 408. FIG. 4C shows the electromagnetic shield 404, the spacer 406, and the slot antenna 408 of FIG. 4A placed in proximity to electrical circuitry on a printed circuit board 310 (which is typically part of a system or wireless device), where the printed circuit board 310 typically has a ground plane (not shown); in one embodiment, antenna feed 412 is soldered to and excited by an antenna feed connection (not shown) on the printed circuit board 310.

Those having ordinary skill in the art will recognize that the specific dimensions of the portions of the electromagnetic shields, spacers, and slot antennas described and/or illustrated herein will vary depending upon the frequency or frequencies of interest, and that specific dimensions for particular applications can be achieved via a reasonable amount of experimentation well within the ambit of one having ordinary skill in the art. However, as an aid to understanding, following the inventors provide their design-choice “rule of thumb” which they use as an aid in determining actual dimensions for particular applications.

As a rule of thumb, during the design-choice process the inventors view the slot antenna as follows. The inventors view a slot antenna as consisting of a rectangular slot (e.g., length L, height H, with L>H as depicted in FIGS. 4B and 4C) cut in a highly conductive surface. Because the slot is closed with conductive material at both ends, the inventors assume, for sake of expediency, that it (the slot) cannot support an electric field at the ends. However, the inventors also surmise that any electromagnetic (EM) wave that has nulls in the electric field spaced a distance L apart can resonate with the slotted structure. The inventors further surmise that, in an EM wave, nulls occur at every integer multiple of ½ wavelength. Thus, the inventors treat the gap of the slotted structure as a resonant structure that can effectively interact with electromagnetic fields of a few particular wavelengths (e.g., 2×L). As a design-choice rule of thumb, the inventors surmise that the width W, and the thickness of the conductive material will alter the range of wavelengths (bandwidth) over which the slot will be resonant in a way that is not easily calculated. Accordingly, in practice the inventors recognize that precise dimensions of a slot antenna needed to obtain a particular performance objective are best determined by numerical simulation and then empirical testing. With reference now to FIGS. 5A-5B, depicted is an example of forming a structure in accordance with various aspects of the alternate process implementations shown in FIGS. 1 and 2, as well as an example of how the formed structure can be employed in a device or system. FIG. 5A depicts a substantially continuous piece of conductive material 300 (e.g., a piece of sheet metal), which has been formed such that when the substantially continuous piece of conductive material 300 is bent along dashed lines 502, at least one electromagnetic shield and at least one antenna will be formed. FIG. 5B illustrates the substantially continuous piece of conductive material 300 (e.g., a piece of sheet metal) where the metal has been bent (or stamped) along dashed lines 502 shown in FIG. 5A in order to form an electromagnetic shield 504, a spacer 506, and a PIFA antenna 508 having antenna feed 512. In general, the spacer 506 has dimensions and is oriented to provide a separation between the electromagnetic shield 504 and the PIFA antenna 508, where the separation is generally, but not always, at least 1/50^{th} of the wavelength associated with an operational frequency of interest of the PIFA antenna 508. FIG. 5B further shows the electromagnetic shield 504, the spacer 506, and the PIFA antenna 508 of FIG. 5A placed in proximity to electrical circuitry on a printed circuit board 310 (which is typically part of a system or wireless device), where the printed circuit board 310 typically has a ground plane (not shown) on the side facing the antenna, and electrical circuits on the other side, inside the shield; in one embodiment, antenna feed 512 is soldered to and excited by an antenna feed connection (not shown) on the printed circuit board 310.With reference now to FIGS. 6A-6B, depicted is an example of forming a structure in accordance with various aspects of the alternate process implementations shown in FIGS. 1 and 2, as well as an example of how the formed structure can be employed in a device or system. FIG. 6A depicts a substantially continuous piece of conductive material 300 (e.g., a piece of sheet metal), which has been formed such that when the substantially continuous piece of conductive material 300 is bent along the dashed lines 602, at least one electromagnetic shield and at least one antenna will be formed. FIG. 6B illustrates the substantially continuous piece of conductive material 300 (e.g., a piece of sheet metal) where the metal has been bent (or stamped) along dashed lines 602 shown in FIG. 6A in order to form the electromagnetic shield 604, the spacer 606, and the PIFA antenna 608 having antenna feed 612. In general, the spacer 606 has dimensions and is oriented to provide a separation between the electromagnetic shield 604 and the PIFA antenna 608, where the separation is generally, but not always, at least 1/50^{th} of the wavelength associated with an operational frequency of interest of the PIFA antenna 608. FIG. 6B further shows the electromagnetic shield 604, the spacer 606, and the PIFA antenna 608 of FIG. 6A placed in proximity to electrical circuitry on a printed circuit board 310 (which is typically part of a system or wireless device), where the printed circuit board 310 typically has a ground plane (not shown); in one embodiment, antenna feed 612 is soldered to and excited by an antenna feed connection (not shown) on the printed circuit board 310.

Those having ordinary skill in the art will recognize that the specific dimensions of the portions of the electromagnetic shields, spacers, and PIFA and/or Inverted F antennas described and/or illustrated herein will vary depending upon the frequency or frequencies of interest, and that specific dimensions for particular applications can be achieved via a reasonable amount of experimentation well within the ambit of one having ordinary skill in the art. However, as an aid to understanding, following the inventors provide their design-choice “rules of thumb” which they use as an aid in determining actual dimensions for particular applications.

As a rule of thumb, during the design-choice process the inventors view the PIFA and/or Inverted F antennas as follows. The inventors simplistically view a PIFA/Inverted F antenna as being similar to a slot antenna in that it consists of an air space (length L, width W (the Inverted F is treated as a PIFA antenna with a very small W), and height H, with L>W>H for the PIFA antennas (e.g., as depicted in FIGS. 5B, 6B, and 8) and with L>H for the Inverted F antennas (e.g., as depicted in FIGS. 3B, 3C, and 7)) between highly conductive surfaces; however, the inventors also treat the PIFA/Inverted F antenna as 3 dimensional. In the case of a PIFA/Inverted F antenna, the inventors view the gap as closed by conductive material at one end, and open to space at the other. Accordingly, during the design-choice process the inventors surmise that a PIFA/Inverted F antenna will resonate with an electromagnetic wave that has a null in the electric field at a distance L from a null in the magnetic field. In other words, the inventors surmise that the distance L should preferably correspond to an odd multiple of ¼ wavelength. Therefore, the inventors treat a PIFA/Inverted F antenna as acting as a resonant antenna for a signal with a wavelength of 4×L, among others. As with the slot antenna, the other dimensions of the gap, including W and H affect the bandwidth and efficiency of the antenna and minimally alter the wavelength. Again, as with the slot antenna, in practice the inventors define each particular individual application and then model the performance of each PIFA/Inverted F antenna numerically, after which an actual physical PIFA/Inverted F antenna is built and fine-tuned empirically.Although the examples of FIGS. 3A-3C, 4A-4C, 5A-5B, and 6A-6B illustrate the formation and use of types of antennas known in the art as slot, Inverted F, and PIFA antennas, those having ordinary skill in the art will appreciate that the example illustrated in examples of FIGS. 3A-3C, 4A-4C, 5A-5B, and 6A-6B can be adapted to various other types of electromagnetic shields and electromagnetic antennas (such as the various other types of shields and antennas referred to above) via only a small amount of experimentation. Examples of alternate antennas beyond those explicitly illustrated herein appear in KRAUS, J. D., ANTENNAS, MCGRAW-HILL, NEW YORK, 1988, and/or Hirasawa, K., and M. Haneishi, ed., Introductory Analysis, Design, and Measurement of Small or Low Profile Antennas, Dedham, Mass.: Artech House, 1992, which are hereby incorporated by reference herein in their entireties. In addition to the foregoing, in the course of performing one PIFA antenna implementation, the inventors discovered a modification to a PIFA antenna can result in enhanced performance in some applications.

Referring now to FIG. 8, shown is a PIFA antenna modified to provide enhanced operation in some applications. Depicted in FIG. 8 is that, for a particular frequency (i.e., wavelength) of interest, the length of the air gap on a PIFA antenna may be shortened below the length (L) ordinarily required in the related art by terminating what would ordinarily be the open end of the PIFA antenna with a capacitor 800. Illustrated is that in one implementation the capacitor 800 can be fabricated by a small area of conductor spaced above a ground plane by a narrow air gap (and perhaps an additional layer of printed circuit board dielectric, which is not shown). Note that the small capacitor is integral with the end of the PIFA antenna structure. Alternatively, a discrete capacitor could be used.Although the examples set forth above illustrated the formation of a type of electromagnetic shield known in the art as a “can,” or “box,” those having ordinary skill in the art will recognize that the examples given can be adapted to form alternative types of shields with a minimum amount of experimentation well within the ambit of one having ordinary skill in the art. Examples of alternative shields beyond those explicitly illustrated are partial enclosure (e.g., open in one or more directions), perforated enclosures, and screen enclosures. With respect to the devices described above, for sake of simplicity, the antennas (e.g., the antennas 308, 408, 508, and 608 of FIGS. 3B, 4B, 5B, and 6B, respectively) have been shown oriented transverse to their respective spacers. However, other orientations of the antennas relative to their spacers are contemplated. Following is one example of such alternate orientations.Referring now to FIG. 7, shown is that the Inverted F antenna 308 of FIG. 3B can be alternatively oriented below spacer 306 (e.g., which could be achieved by bending the sheet metal such that Inverted F antenna 308, as it is shown in FIG. 3B, is rotated 180 degrees about an axis formed by the intersection of the Inverted F antenna 308 and the spacer 306). Those skilled in art will recognize that with respect to the orientation shown of Inverted F antenna 308, insofar as the antenna feed 312 is no longer directly above the printed circuit board 310, an electrical connection will need to be established between antenna feed 312 and its corresponding antenna feed connection on the printed circuit board 310; establishing such a connection may be achieved via a minimum amount of experimentation well within the ambit of those having ordinary skill in the art. Although FIG. 7 has only described one alternate orientation in relation to one specific antenna implementation (e.g., the antenna 308), those skilled in art will appreciate that FIG. 7 will be understood by those having ordinary skill in the art as illustrative of many other alternate implementations whereby various antennas may be rotated about the plane formed by their respective spacers. Although the examples set forth herein have illustrated the spacers (e.g., the spacers 306, 406, 506, and 606 of FIGS. 3B, 4B, 5B, and 6B, respectively) as oriented perpendicular to their respectively associated electromagnetic shields and antennas, it is to be understood that such perpendicular orientations are merely exemplary. That is, the spacers described herein may have virtually any orientation, as well as virtually any shape, so long as the spacers ultimately provide separation between the electromagnetic shield and antenna sufficient to the application in which the electromagnetic shield and antenna are being employed. Electrical circuitry has been described herein. Those having ordinary skill in the art will recognize that the electrical circuitry discussed herein can be conceived of as either representing an electromagnetic source or an electromagnetic sink depending upon context. For example, if the concern is to shield such electrical circuitry from emissions external to the electrical circuitry, the electrical circuitry may be conceived of as an electromagnetic sink. Alternatively, if the concern is to shield other devices from electromagnetic emissions produced by the electrical circuitry of the printed circuit board 310, the electrical circuitry may be conceived of as an electromagnetic source. Those having ordinary skill in the art will appreciate that the electromagnetic shield and antenna formed in substantial electrical current communication, various implementations of which have been described herein, will be particularly useful in a wide variety of systems, such as wireless communications systems, Global Positioning Systems, wireless modem systems, wireless factory automation systems, or other systems which employ both electrical circuitry and wireless links, etc. Those having ordinary skill in the art will further appreciate that the electromagnetic shield and an antenna formed in substantial electrical current communication, various implementations of which have been described herein, will also be particularly useful in a wide variety of devices, such as cellular-enabled wireless devices, TDMA-enabled wireless devices, CDMA-enabled wireless devices, GPS-enabled wireless devices, email-enabled wireless devices, etc.

The foregoing described implementations depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular implementations have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

1. A method of manufacture, said method comprising:
forming at least one electromagnetic shield and at least one antenna in substantial electrical current communication.

2. The method of claim 1, wherein said forming at least one electromagnetic shield and at least one antenna in substantial electrical current communication comprises:
spacing the at least one electromagnetic shield apart from the at least one antenna.

3. The method of claim 1, wherein the at least one antenna comprises:
a Planar Inverted F Antenna (PIFA).

4. The method of claim 1, wherein the at least one antenna comprises:
a slot antenna.

5. The method of claim 1, wherein the at least one antenna comprises:
a dipole antenna.

6. The method of claim 1, wherein said forming at least one electromagnetic shield and at least one antenna in substantial electrical current communication comprises:
forming the at least one electromagnetic shield or the at least one antenna from a metal.

7. The method of claim 1, wherein said forming at least one electromagnetic shield and at least one antenna in substantial electrical current communication comprises:
forming the at least one electromagnetic shield or the at least one antenna from a conductive material.

8. The method of claim 1, wherein said forming at least one electromagnetic shield and at least one antenna in substantial electrical current communication comprises:
punching the at least one electromagnetic shield or the at least one antenna from a sheet of conductive material.

9. The method of claim 1, wherein said forming at least one electromagnetic shield and at least one antenna in substantial electrical current communication comprises:
stamping the at least one electromagnetic shield or the at least one antenna from a sheet of conductive material.

10. The method of claim 1, wherein said forming at least one electromagnetic shield and at least one antenna in substantial electrical current communication comprises:
bending apiece of conductive material.

11. The method of claim 1, wherein said forming at least one electromagnetic shield and at least one antenna in substantial electrical current communication comprises:
molding the at least one electromagnetic shield and the at least one antenna.

12. The method of claim 11, wherein said molding the at least one electromagnetic shield and the at least one antenna comprises:
injection molding the at least one electromagnetic shield and the at least one antenna.

13. The method of claim 1, further comprising:
placing the at least one electromagnetic shield and the at least one antenna in proximity to an electromagnetic source or sink.

14. The method of claim 13, wherein said placing the at least one electromagnetic shield and the at least one antenna in proximity to an electromagnetic source or sink further comprises:
placing an antenna feed of the at least one antenna in electrical current communication an antenna feed connection of a printed current board.

15. The method of claim 13, wherein said placing the at least one electromagnetic shield and the at least one antenna in proximity to an electromagnetic source or sink further comprises:
placing the at least one electromagnetic shield and the at least one antenna in proximity to electrical circuitry selected from an electrical-circuitry group including but not limited to electrical circuitry having at least one discrete electrical circuit, electrical circuitry having at least one integrated circuit, electrical circuitry having at least one application specific integrated circuit, electrical circuitry forming a general purpose computing device configured by a computer program, electrical circuitry forming a memory device, electrical circuitry forming a transmitter, electrical circuitry forming a receiver, and electrical circuitry forming a communications device.

16. The method of claim 15, wherein the electrical circuitry comprises:
a printed circuit board having the electrical circuitry.

17. A system comprising:
at least one electromagnetic shield and at least one antenna formed in substantial electrical current communication.

18. The system of claim 17, wherein said at least one electromagnetic shield and at least one antenna formed in substantial electrical current communication comprises:
a spacer between the at least one electromagnetic shield and the at least one antenna.

19. The system of claim 17, wherein the at least one antenna comprises:
a Planar Inverted F Antenna (PIFA).

20. The system of claim 17, wherein the at least one antenna comprises:
a slot antenna.

21. The system of claim 17, wherein the at least one antenna comprises:
a dipole antenna.

22. The system of claim 17, wherein said at least one electromagnetic shield and at least one antenna formed in substantial electrical current communication comprises:
said at least one electromagnetic shield or at least one antenna formed from a metal.

23. The system of claim 17, wherein said at least one electromagnetic shield and at least one antenna formed in substantial electrical current communication comprises:
said at least one electromagnetic shield or at least one antenna formed from a conductive material.

24. The system of claim 17, further comprising:
the at least one electromagnetic shield and the at least one antenna in proximity to an electromagnetic source.

25. The system of claim 24, wherein the at least one electromagnetic shield and the at least one antenna in proximity to an electromagnetic source comprises:
an antenna feed of the at least one antenna in electrical communication with an antenna feed connection of a printed circuit board.

26. The system of claim 24, wherein the at least one electromagnetic shield and the at least one antenna in proximity to an electromagnetic source comprises:
the at least one electromagnetic shield and the at least one antenna in proximity to electrical circuitry selected from an electrical-circuitry group including but not limited to electrical circuitry having at least one discrete electrical circuit, electrical circuitry having at least one integrated circuit, electrical circuitry having at least one application specific integrated circuit, electrical circuitry forming a general purpose computing device configured by a computer program, electrical circuitry forming a memory device, electrical circuitry forming a transmitter, electrical circuitry forming a receiver, and electrical circuitry forming a communications device.

27. The system of claim 26, wherein the electrical circuitry comprises:
a printed circuit board having the electrical circuitry.

28. A wireless device comprising:
at least one electromagnetic shield and at least one antenna formed in substantial electrical current communication.

29. The wireless device of claim 28, wherein said at least one electromagnetic shield and at least one antenna formed in substantial electrical current communication comprises:
a spacer between the at least one electromagnetic shield and the at least one antenna.

30. The wireless device of claim 28, further comprising:
said wireless device selected from the wireless-device group including but not limited to at least one cellular-enabled wireless device, at least one TDMA-enabled wireless device, at least one CDMA-enabled wireless device, at least one GPS-enabled wireless device, and at least one email-enabled wireless device.
